(19) United States
(12) Patent Application Publication
(10) Pub. No.: US 2014/0186741 A1
(43) Pub. Date: Jul. 3, 2014

(54) SERIES-CONNECTED FUEL CELL ASSEMBLY

(71) Applicant: NATIONAL CENTRAL UNIVERSITY, Zhongli City (TW)

(72) Inventors: Chung-Jen TSENG, Zhongli City (TW); Tad TSAI, Changhua County (TW); Guan-Ren LIN, New Taipei City (TW)

(73) Assignee: NATIONAL CENTRAL UNIVERSITY, Zhongli City (TW)

(21) Appl. No.: 13/842,696

(22) Filed: Mar. 15, 2013

(30) Foreign Application Priority Data
Dec. 28, 2012 (TW) 101151242

(51) Int. Cl. H01M 8/24; H01M 8/10

(52) U.S. Cl. CPC H01M 8/2465; H01M 8/10
USPC 429/465

(57) ABSTRACT

A series-connected fuel cell assembly includes a plurality of electrode plates and a plurality of exchange membranes. Each of the exchange membranes is held between two of the electrode plates. The electrode plates include at least three outer electrode plates, each of which is provided with a connecting surface. The connecting surface of one of the outer electrode plates faces toward the connecting surfaces of two of the other outer electrode plates. At least one of the exchange membranes is located between every two face-to-face connecting surfaces of the outer electrode plates. As a result, the series-connected fuel cell assembly has the advantages of less thickness, high voltage, simple manufacturing process, and low cost.

### BACKGROUND OF THE INVENTION

1. Field of the Invention

The present invention relates generally to fuel cells and more particularly, to a series-connected fuel cell assembly.

2. Description of the Related Art

A conventional fuel cell primarily comprises an anode plate, a cathode plate, and a proton exchange membrane (hereinafter referred to as “PEM”) held between the anode plate and the cathode plate. As long as the fuel cell is continuously supplied with oxygen and hydrogen, hydrogen will be decomposed at the anode plate to produce protons which will flow to the cathode plate through the PEM, and electrons which will circulate to the cathode plate through external circuits so that the protons, the electrons, and oxygen will be reduced to water at the cathode plate and thus an electric current will be generated in the external circuits.

The commercially available fuel cell product mostly comprises a plurality of single fuel cells structurally mentioned above, which are stacked upon one another to be electrically connected in series, so that the fuel cell product can generate higher voltage. However, such stacked fuel cell product is too thick to be used conveniently.

In addition, some commercially available fuel cell products comprise circuits on cathode and anode plates thereof, wherein the single fuel cells can jointly share the cathode and anode plates for connecting the single fuel cells in series or parallel so that the fuel cell product can generate higher voltage. In this way, such fuel cell product is though relatively thinner, but its manufacturing process is relatively more complicated and high-cost.

### SUMMARY OF THE INVENTION

The present invention has been accomplished in view of the above-noted circumstances. It is an objective of the present invention to provide a series-connected fuel cell assembly which has the advantages of less thickness, high voltage, simple manufacturing process, and low cost.

To attain the above objective, the present invention provides a series-connected fuel cell assembly which comprises a plurality of electrode plates and a plurality of exchange membranes. Each of the exchange membranes is held between two of the electrode plates. The electrode plates comprise at least three outer electrode plates, each of which is provided with a connecting surface. The connecting surface of one of the outer electrode plates faces toward the connecting surfaces of two of the other outer electrode plates. At least one of the exchange membranes is located between every two face-to-face connecting surfaces of the outer electrode plates.

As a result, each of the exchange membranes and the two electrode plates connected with the exchange membrane jointly constitute a single fuel cell. Except the electrode plates for connection with external circuits, each of the remaining electrode plates can be shared by two single fuel cells to make the two single fuel cells be connected in series. In this way, compared with the conventional stacked fuel cell product and the conventional fuel cell product having the built-in circuits under the same voltage, the present invention is less thick than the former and both simpler in manufacturing process and lower in cost than the latter.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a series-connected fuel cell assembly provided by a first preferred embodiment of the present invention;

FIG. 2 is an exploded perspective view of the series-connected fuel cell assembly provided by the first preferred embodiment of the present invention;

FIG. 3 is an exploded perspective view of a series-connected fuel cell assembly provided by a second preferred embodiment of the present invention;

FIG. 4 is an exploded perspective view of a series-connected fuel cell assembly provided by a third preferred embodiment of the present invention;

FIG. 5 is an exploded perspective view of a series-connected fuel cell assembly provided by a fourth preferred embodiment of the present invention; and

FIG. 6 is an exploded perspective view of a series-connected fuel cell assembly provided by a fifth preferred embodiment of the present invention.

### DETAILED DESCRIPTION OF THE INVENTION

First of all, it is to be mentioned that same reference numerals used in the following preferred embodiments and the appendix drawings designate same or similar elements throughout the specification for the purpose of concise illustration of the present invention.

Besides, when it is mentioned that an element is located between two other elements, it means that between the latter elements, there could be only the former element or further another or more other elements; when it is mentioned that an element is held between two other elements, it means that there is only the former element between the latter elements.

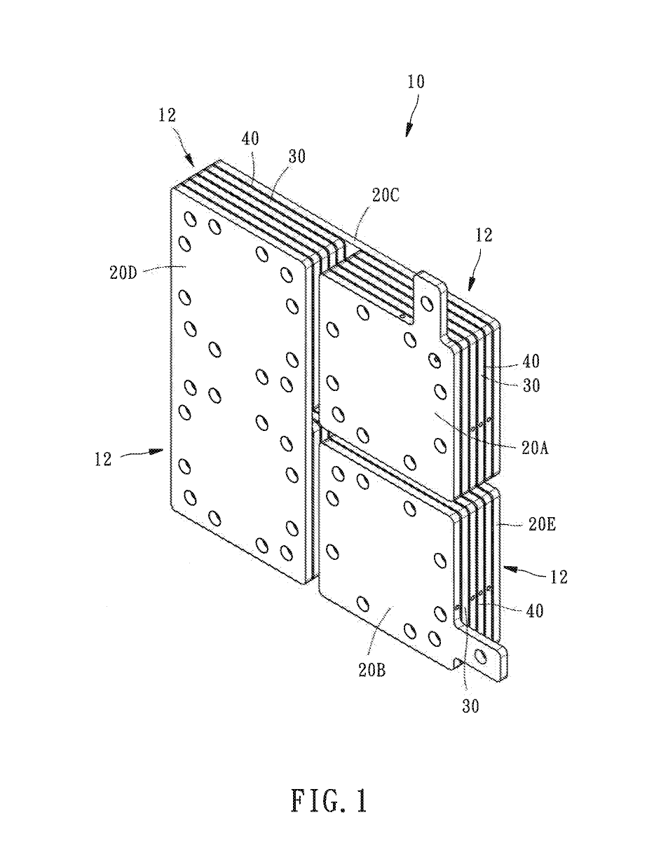

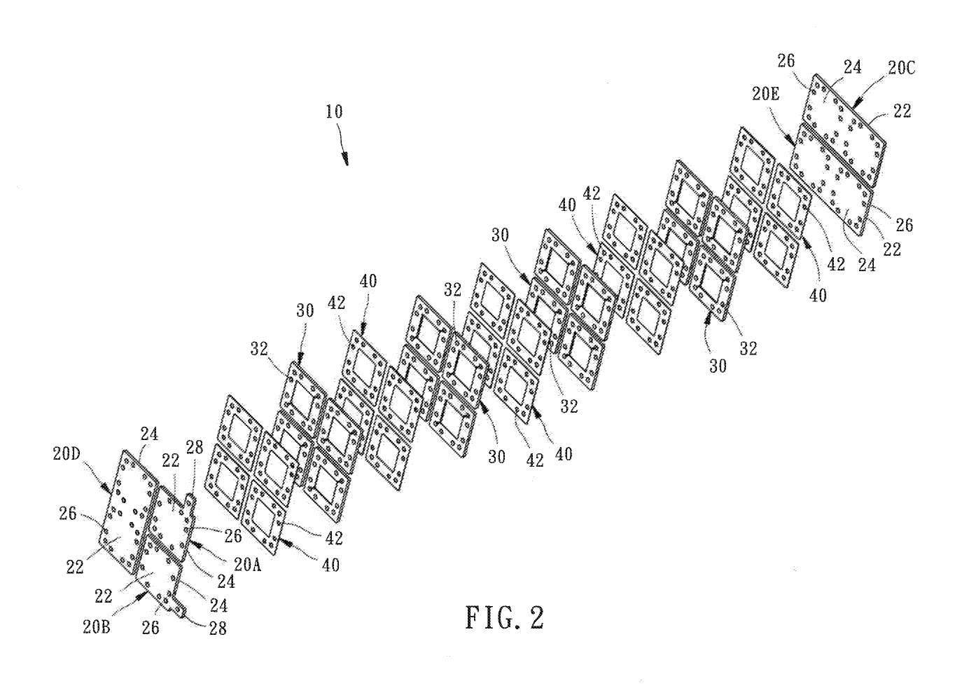

Referring to FIGS. 1-2, a series-connected fuel cell assembly 10, which is provided by a first preferred embodiment of the present invention, comprises five outer electrode plates 20A-20E, sixteen inner electrode plates 30, and twenty exchange membranes 40.

The outer electrode plates 20A-20E, which can be made of metal or other electrically conductive material, comprise two smaller ones, one of which is an external connecting anode plate 20A and the other is an external connecting cathode plate 20B, and three bigger ones which are a first bridge plate 20C, a second bridge plate 20D, and a third bridge plate 20E. Each of the outer electrode plates 20A-20E is provided with an outer surface 22, a connecting surface 24, and a plurality of through holes 26 running through the outer surface 22 and the connecting surface 24. The external connecting anode plate 20A and the external connecting cathode plate 20B are further provided with an external connecting portion 28 each.

Each of the inner electrode plates 30, which can also be made of metal or other electrically conductive material, has approximately the same size as that of the external connecting anode plate 20A or the external connecting cathode plate 20B and is provided with a plurality of through holes 32 corresponding to the through holes 26 in position.

The exchange membranes 40 can be the conventional PEMs, which have electrolytes for transmitting protons. Besides, each of the exchange membranes 40 is also provided with a plurality of through holes 42 corresponding to the through holes 26 in position.

The connecting surface 24 of the first bridge plate 20C faces toward the connecting surfaces 24 of the external connecting anode plate 20A and the second bridge plate 20D. The connecting surface 24 of the third bridge plate 20E faces toward the connecting surfaces 24 of the external connecting cathode plate 20B and the second bridge plate 20D. Four of the inner electrode plates 30 and five of the exchange membranes 40 are located between every two face-to-face connecting surfaces 24. Each of the exchange membranes 40 is held between one of the inner electrode plates 30 and one of the outer electrode plates 20A-20E or between two of the inner electrode plates 30.

Some through holes 26, 32, 42 of the electrode plates 20A-20E, 30 and the exchange membranes 40 are adapted to be inserted by some fasteners, such as screws, for making the electrode plates 20A-20E, 30 and the exchange membranes 40 connected with one other. Each of the exchange membranes 40 and two of the electrode plates 20A-20E, 30 connected with the exchange membrane 40 can be regarded as a single fuel cell, and namely, the series-connected fuel cell assembly 10 comprises twenty single fuel cells. These single fuel cells constitute four matrix-arranged cell stacks 12 which comprise five stacked single fuel cells each. Each of the bridge plates 20C-20E is shared by two adjacent single fuel cells belonging to different cell stacks 12 to serve as the anode plate and the cathode plate of said two single fuel cells, respectively. Each of the inner electrode plates 30 is shared by two stacked single fuel cells belonging to the same cell stack 12 to serve as the anode plate and the cathode plate of said two single fuel cells, respectively.

The other through holes 26, 32, 42 of the electrode plates 20A-20E, 30 and the exchange membranes 40 serve as flow channels for oxygen and hydrogen so that the single fuel cells can discharge electricity by chemical reactions with oxygen and hydrogen. In addition, the external connecting portions 28 of the external connecting anode plate 20A and the external connecting cathode plate 20B are adapted to be connect d with external circuits (not shown) so as to be electrically connected with anode and cathode of an electric apparatus (not shown) respectively, further supplying electricity to the electric apparatus.

The single fuel cells of the same cell stack 12 are series-connected and the fuel cell stacks 12 are also series-connected by means of the bridge plates 20C-20E, so the voltage generated by the series-connected fuel cell assembly 10 is twenty times more than that of a said single fuel cell. The area of each single fuel cell of the series-connected fuel cell assembly 10 can be a quarter of the area of the modular stacked fuel cell, so in this way, the series-connected fuel cell assembly 10 with the same size can generate the voltage of four times more than that of the conventional stacked fuel cell product. Compared with the conventional stacked fuel cell product which generates the same voltage with the assembly 10, the assembly 10 is much less thick. Besides, compared with the conventional fuel cell product having built-in circuits, the assembly 10 is simpler in manufacturing process and lower in cost.

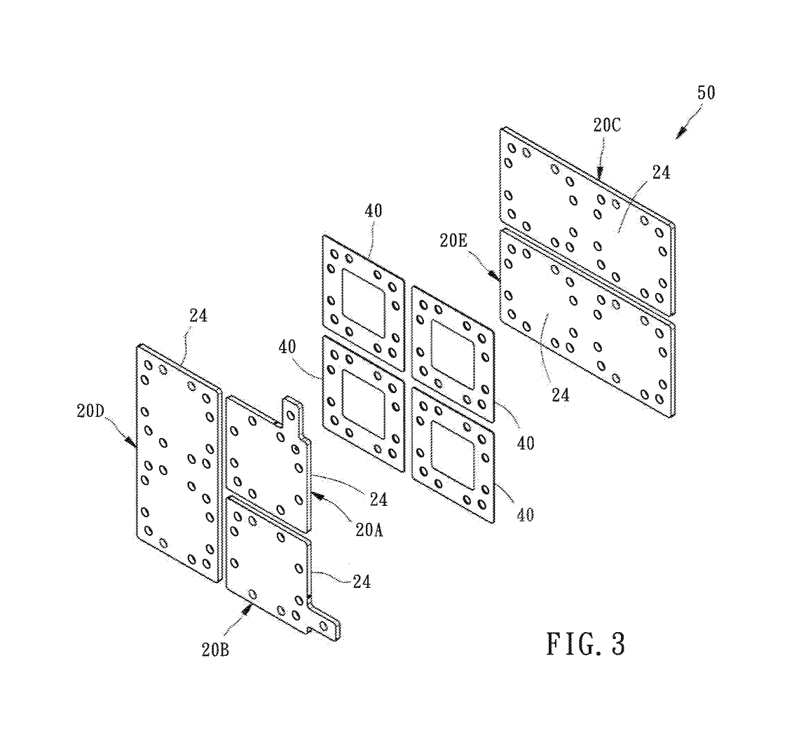

The primary characteristic of the prevent invention is electrically connecting the single fuel cells in series by means of the bridge plates, thereby making the series-connected fuel cell assembly have the advantages of high voltage and less thickness. Therefore, any arrangement with such characteristic belongs to the scope of the present invention. That means the series-connected fuel cell assembly provided by the present invention also can be provided without any cell stack formed of a plurality of stacked single fuel cells, such as the series-connected fuel cell assemblies 50, 60, 70, 80 as shown in FIGS. 3-6 provided by second, third, fourth, and fifth embodiments of the present invention to be illustrated below, respectively.

Referring to FIG. 3, the series-connected fuel cell assembly 50 differs from the aforesaid series-connected fuel cell assembly 10 in that only one exchange membrane 40 is located between every two face-to-face connecting surfaces 24 of the outer electrode plates 20A-20E. As a result, the voltage generated by the series-connected fuel cell assembly 50 is four times more than that of one single fuel cell.

In fact, as long as the series-connected fuel cell assembly provided by the present invention comprises at least three outer electrode plates and at least one of the exchange membranes is mounted between the connecting surface of one of the at least three outer electrode plates, i.e. the bridge plate, and the connecting surfaces of two of the other outer electrode plates, the series-connected fuel cell assembly can achieve the objective of electrically connecting single fuel cells in series to raise the voltage without increasing the thickness.

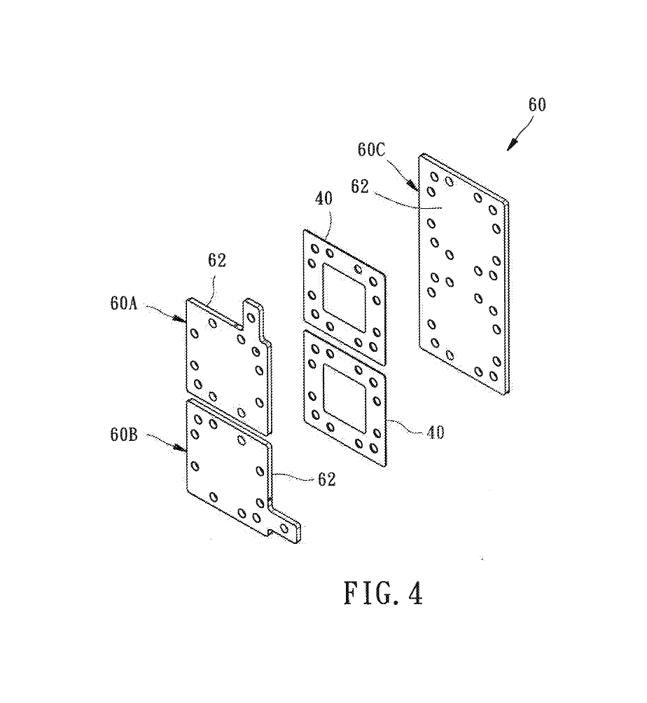

For example, the outer electrode plates of the series-connected fuel cell assembly 60 shown in FIG. 4 only comprise an external connecting anode plate 60A, an external connecting cathode plate 60B, and a bridge plate 60C. There is an exchange membrane 40 located between the connecting surfaces 62 of the external connecting anode plate 60A and the bridge plate 60C. There is another exchange membrane 40 located between the connecting surfaces 62 of the external connecting cathode plate 60B and the bridge plate 60C. As a result, the series-connected fuel cell assembly 60 has the same thickness with that of one single fuel cell and generates the voltage of two times more than that of said one single fuel cell.

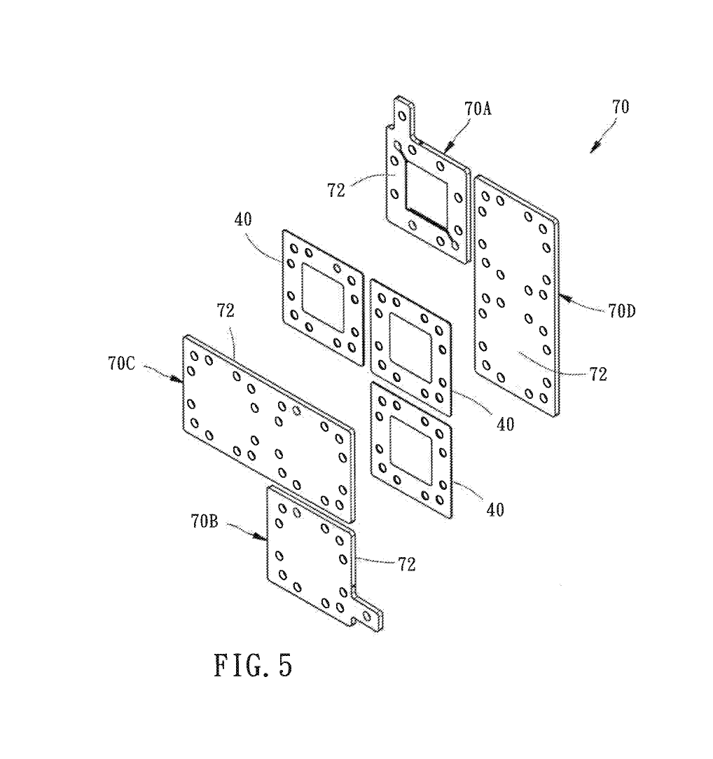

Another example is the series-connected fuel cell assembly 70 shown in FIG. 5, wherein the outer electrode plates comprise an external connecting anode plate 70A, an external connecting cathode plate 70B, and two bridge plates 70C, 70D. There is an exchange membrane 40 located between the connecting surfaces 72 of the external connecting anode plate 70A and the bridge plate 70C. There is another exchange membrane 40 located between the connecting surfaces 72 of the external connecting cathode plate 70B and the bridge plate 70D. There is another exchange membrane 40 located between the connecting surfaces 72 of the bridge plates 70C, 70D. As a result, the series-connected fuel cell assembly 70 has the same thickness with that of one single fuel cell and generates the voltage of three times more than that of said one single fuel cell.

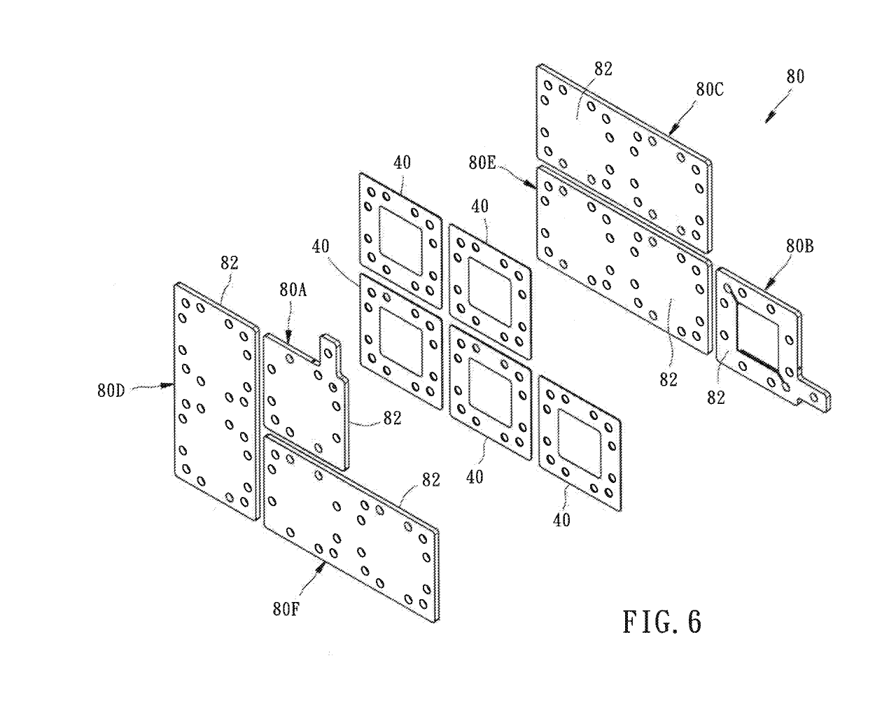

Applying the concept of electrically connecting single fuel cells in series by means of bridge plates, the series-connected fuel cell assembly provided by the present invention can be expanded to the one having more than three bridge plates. For example, the outer electrode plates of the series-connected fuel cell assembly 80 shown in FIG. 6 comprise an external connecting anode plate 80A, an external connecting cathode plate 80B, and four bridge plates 80C-80F. The connecting surface 82 of the bridge plate 80C face toward the connecting surfaces 82 of the external connecting anode plate 80A and the bridge plate 80D. The connecting surface 82 of the bridge plate 80F face toward the connecting surfaces 82 of the external connecting cathode plate 80B and the bridge plate 80E. Besides, the connecting surfaces 82 of the bridge plates 80D, 80E face toward each other. There is an exchange membrane 40 located between every two connecting surfaces 82 facing toward each other. As a result, the series-connected fuel cell assembly 80 has the same thickness with that of one single fuel cell and generates the voltage of five times more than that of said one single fuel cell.

In each of the aforesaid series-connected fuel cell assemblies 50, 60, 70, 80, more exchange membranes 40 separated by inner electrode plates 30 can be located between every two face-to-face connecting surfaces of the outer electrode plates so as to constitute the fuel cell stacks as illustrated in the first embodiment, thereby further raising the voltage generated by the series-connected fuel cell assemblies 50, 60, 70, 80.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A series-connected fuel cell assembly comprising a plurality of electrode plates and a plurality of exchange membranes, wherein each of the exchange membranes is held between two of the electrode plates, the electrode plates having at least three outer electrode plates, each of which is provided with a connecting surface, the connecting surface of one of the outer electrode plates facing toward the connecting surfaces of two of the other outer electrode plates, at least one of the exchange membranes being located between every two face-to-face connecting surfaces of the outer electrode plates.

2. The series-connected fuel cell assembly as claimed in claim 1, wherein the electrode plates further comprise a plurality of inner electrode plates, a plurality of the exchange membranes and at least one of the inner electrode plates being located between every two face-to-face connecting surfaces of the outer electrode plates, each of the exchange membranes being held between one of the inner electrode plates and one of the outer electrode plates or between two of the inner electrode plates.

3. The series-connected fuel cell assembly as claimed in claim 1, wherein the outer electrode plates comprise an external connecting anode plate, an external connecting cathode plate, and at least three bridge plates, the connecting surfaces of two of the bridge plates not only facing toward the connecting surfaces of the external connecting anode plate and the external connecting cathode plate respectively but also facing toward the connecting surface of one of the other bridge plates or the connecting surfaces of two of the other bridge plates respectively, the connecting surface of either of said the other bridge plates facing toward the connecting surfaces of two of the bridge plates, at one of the exchange membranes being located between every two face-to-face connecting surfaces of the outer electrode plates.

4. The series-connected fuel cell assembly as claimed in claim 3, wherein the electrode plates further comprise a plurality of inner electrode plates, a plurality of the exchange membranes and at least one of the inner electrode plates being located between very two face-to-face connecting surfaces of the outer electrode plates, each of the exchange membranes being held between one of the inner electrode plates and one of the outer electrode plates or between two of the inner electrode plates.

5. The series-connected fuel cell assembly as claimed in claim 3, wherein the bridge plates comprise a first bridge plate, a second bridge plate, and a third bridge plate, the connecting surface of the first bridge plate facing toward the connecting surface of the external connecting anode plate, the connecting surface of the third bridge plate facing toward the connecting surface of the external connecting cathode plate, the connecting surface of the second bridge plate facing toward the connecting surfaces of the first bridge plate and the third bridge plate.

6. The series-connected fuel cell assembly as claimed in claim 5, wherein the electrode plates further comprise a plurality of inner electrode plates, a plurality of the exchange membranes and at least one of the inner electrode plates being located between every two face-to-face connecting surfaces of the outer electrode plates, each of the exchange membranes being held between one of the inner electrode plates and one of the outer electrode plates or between two of the inner electrode plates.

7. The series-connected fuel cell assembly as claimed in claim 1, wherein the outer electrode plates comprise an external connecting anode plate, an external connecting cathode plate, and a bridge plate, the connecting surfaces of the external connecting anode plate and the bridge plate facing toward each other and at least one of the exchange membranes being located between the connecting surfaces of the external connecting anode plate and the bridge plate, the connecting surfaces of the external connecting cathode plate and the bridge plate facing toward each other and at least one of the exchange membranes being located between the connecting surfaces of the external connecting cathode plate and the bridge plate.

8. The series-connected fuel cell assembly as claimed in claim 7, wherein the electrode plates further comprise a plurality of inner electrode plates, a plurality of the exchange membranes and at least one of the inner electrode plates being located between every two face-to-face connecting surfaces of the outer electrode plates, each of the exchange membranes being held between one of the inner electrode plates and one of the outer electrode plates or between two of the inner electrode plates.

9. The series-connected fuel cell assembly as claimed in claim 1, wherein the outer electrode plates comprise an external connecting anode plate, an external connecting cathode plate, and two bridge plates, the connecting surfaces of the external connecting anode plate and one of the bridge plates facing toward each other and at least one of the exchange membranes being located between the connecting surfaces of the external connecting anode plate and said one of the bridge plates, the connecting surfaces of the external connecting cathode plate and the other bridge plate facing toward each other and at least one of the exchange membranes being located between the connecting surfaces of the external connecting cathode plate and said the other bridge plate, the connecting surfaces of the bridge plates facing toward each other and at least one of the exchange membranes being located between the connecting surfaces of the bridge plates.

10. The series-connected fuel cell assembly as claimed in claim 9, wherein the electrode plates further comprise a plurality of inner electrode plates, a plurality of the exchange membranes and at least one of the inner electrode plates being located between every two face-to-face connecting surfaces of the outer electrode plates, each of the exchange membranes being held between one of the inner electrode plates and one of the outer electrode plates or between two of the inner electrode plates.
